(19) United States
(12) Patent Application Publication
(10) Pub. No.: US 2025/0299159 A1
(43) Pub. Date: Sep. 25, 2025

(54) Intelligent System for Predicting the Harmonized Commodity Description and Coding System HS Code for Commercial Products

(71) Applicant: Manafeth Alwatania Information Technology Co., Riyadh (SA)

(72) Inventor: Adil Mohammad Assiri, Riyadh (SA)

(21) Appl. No.: 18/611,670

(22) Filed: Mar. 20, 2024

(51) Int. Cl. G06Q 10/0875; G06N 20/00

(52) U.S. Cl. CPC G06Q 10/0875; G06N 20/00

(57) ABSTRACT

The present invention is directed at a system of determining a product's HS-Code based on the product's title. The system may employ ML models to assign the HS-Codes. Efficiently and accurately determining a product's HS-Code using machine learning reduces the manual inspection of shipments entering customs, saving time and effort for workers, and improves the detection of prohibited or controlled products.

### FIELD OF THE INVENTION

The present invention relates generally to training a machine learning model, and, in particular, to training a machine learning model to identify restricted and prohibited goods to reduce manual inspection at customs ports.

### SCOPE OF THE PRIOR ART

Saudi Arabia has recently seen a rapid increase in the daily traffic of cross-border trade and the import of new goods, leading to the emergence of several security issues due to the inefficient and often inaccurate nature of customs procedures. Currently, imported goods are manually inspected at customs ports where experts determine the category of the imported goods, labeling each product with its associated Harmonized System (HS-Code). A product's HS-Code determines which duties and taxes apply. Furthermore, products with suspicious HS-Codes are targeted for examination to ensure that no prohibited shipment enters the country, as well as ensuring that the restricted products fulfil the required approvals before entering the country.

Manually inspecting each imported good to determine its category is prone to human error, resulting in a high rate of products mislabeled with the wrong HS-Code. Furthermore, manual inspection is time consuming and reduces the speed of customs clearance, lowering Saudi Arabia's rank in the trading across borders indicator. Consequently, there is a need for a method of determining a product's HS-Code in a timely, consistent, and reliable manner. Preferably, a product's HS-Code is determined solely from the product's title. Technology such as machine learnings can be leveraged to improve the accuracy of determining a product's HS-Code, which, in turn, improves the accuracy of targeting suspicious goods as well as the accuracy of applying appropriate duties and taxes.

### SUMMARY

The present disclosure satisfies the foregoing needs by providing, inter alia, a machine learning model training method and system for the machine learning identification of products.

One aspect of the present invention is directed at a computer-implemented method of training a machine learning general model to determine an HS-Code based on the product's title. This method is computer-implemented and leverages a combination of manual expertise and automated techniques to refine and prepare data for the training phase. Initially, a computing device processes a collection of product titles by removing duplicate words, thereby streamlining the dataset for more effective analysis. Further refinement is achieved by adding contextual words to the product titles, enhancing the model's ability to understand and categorize products more accurately.

Expert intervention plays a critical role in this method. An expert assigns an HS-Code to each product title, ensuring that the model has a reliable set of correct outputs to learn from. Additionally, experts remove non-relevant words from the product titles and verify that the assigned HS-Codes accurately reflect the products based on their titles. This step is crucial for maintaining the integrity and relevance of the training data, thereby improving the model's accuracy.

The computing device applies term frequency and inverse document frequency operations to each product title, transforming them into a set of product terms. This process helps in emphasizing the importance of specific words relative to their frequency across the dataset, aiding in distinguishing between the products more effectively. The method also includes the addition of synonym words to the product titles, further enriching the dataset and allowing the model to recognize and process variations in product descriptions more efficiently.

A training set comprising these refined product terms and their corresponding HS-Codes is then used to train the machine learning model through supervised learning. This approach ensures that the model learns the relationship between product titles and HS-Codes, with the aim of predicting the HS-Code for new, unseen product titles accurately.

Furthermore, the method specifies the use of a random forest algorithm for training the machine learning model. The random forest algorithm is known for its robustness and ability to handle complex datasets with a high degree of accuracy, making it an excellent choice for this application. By integrating manual expertise with advanced machine learning techniques, this method presents a comprehensive and effective solution for automating the assignment of HS-Codes to products based on their titles, potentially streamlining customs and trade processes significantly.

### BRIEF DESCRIPTION OF THE DRAWINGS

The foregoing summary, as well as the following detailed description of preferred variations of the invention, will be better understood when read in conjunction with the appended drawings. For the purpose of illustrating the invention, there is shown in the drawings variations that are presently preferred. It should be understood, however, that the invention is not limited to the precise arrangements shown. In the drawings, where:

FIG. 1 is a simplified block diagram of an HS-Code determination system, according to an embodiment of the present invention.

FIG. 2 is a flowchart of the steps of a method for training a machine learning model to predict HS-Codes, according to one embodiment.

FIG. 3 is a flowchart of the steps of the first training phase of the machine learning model.

FIG. 4 is a flowchart of the steps of the second training phase of the machine learning model.

FIG. 5 is a flowchart of the steps of the third training phrase of the machine learning model.

FIG. 6 is a flowchart of the steps of a first method of determining the HS-Code of a product, according to an embodiment the present invention.

### DETAILED DESCRIPTION

Implementations of the present technology will now be described in detail with reference to the drawings, which are provided as illustrative examples so as to enable those skilled in the art to practice the technology. Notably, the figures and examples below are not meant to limit the scope of the present disclosure to any single implementation or implementations. Wherever convenient, the same reference numbers will be used throughout the drawings to refer to same or like parts.

Moreover, while variations described herein are primarily discussed in the context of a training method and system for machine learning assisted determination of HS-Codes, it will be recognized by those of ordinary skill that the present disclosure is not so limited. In fact, the principles of the present disclosure described herein may be readily applied to the identification and categorization of goods themselves.

In the present specification, an implementation showing a singular component should not be considered limiting; rather, the disclosure is intended to encompass other implementations including a plurality of the same component, and vice-versa, unless explicitly stated otherwise herein. Further, the present disclosure encompasses present and future known equivalents to the components referred to herein by way of illustration.

It will be recognized that while certain aspects of the technology are described in terms of a specific sequence of steps of a method, these descriptions are only illustrative of the broader methods of the disclosure and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

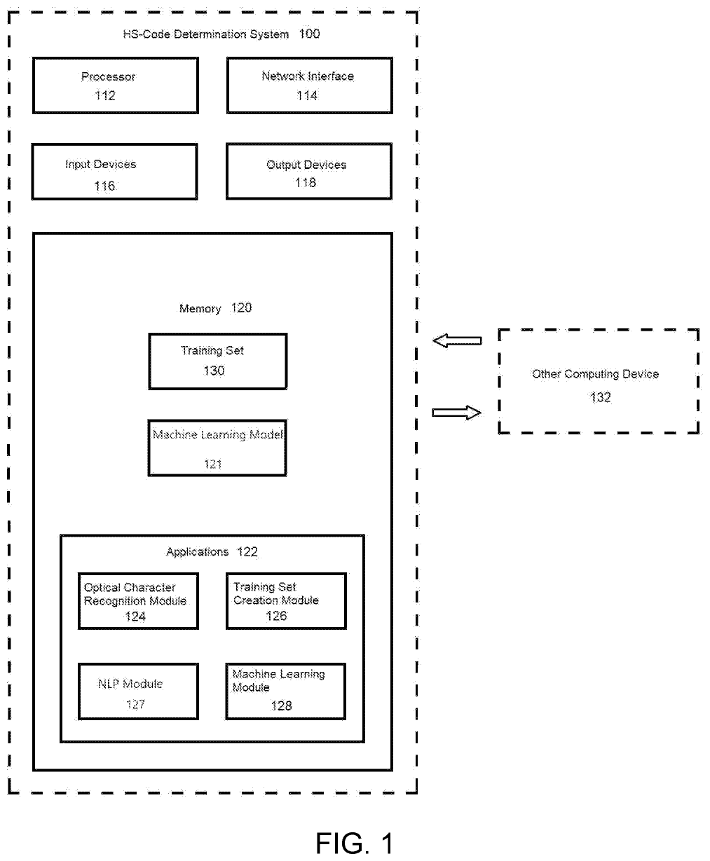

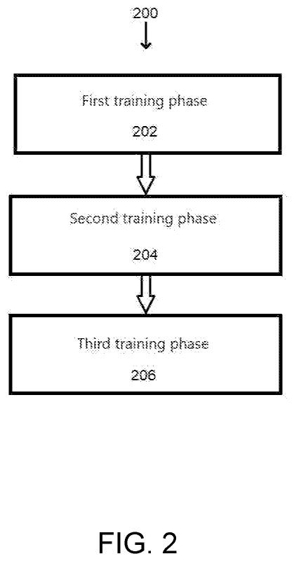

FIG. 1 is simplified block diagram of an HS-Code determination system. The system may determine HS-Codes using a trained ML model produced by the training method of FIG. 2. ML Embodiments of the invention may be implemented via local and remote computing and data storage systems.

In an embodiment, the HS-Code determination system 100 may include at least one processor 112 to execute computer readable program instructions in order to carry out aspects of the present invention and a network interface 114 for network enablement. System 100 may further include input devices 116 configured to accept user inputs, including product titles, and output devices 118 configured to output system data, including HS-Codes.

HS-Code determination system 100 may further include memory 120 in the form of any type of short and long-term computer readable storage medium known in the art. Computer readable storage medium can be a tangible device that can retain and store instructions for use by an instruction execution device such as the processor. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Memory 120 may be loaded with various applications 122 in the form of computer readable program instructions. Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Applications 122 in the form of computer readable program instructions may include an optical recognition module 124 to scan product titles. Applications may further include a training set creation module 126 to create a training set for the ML model 121 a natural language processing module 127. The training set creation module 126 may be configured to perform term frequency and inverse document frequency operations on a set of input product titles. The natural language processing module 127 may be configured to perform natural language processing techniques (NLP techniques) such as grammatical analysis, semantic analysis, and the like. Applications 122 may further include a machine learning module 128 to create ML models. The machine learning module 128 may be configured to perform ML modeling operations on the training set, including, but not limited to, Support Vector Machine, Random Forest, Naïve Bayes, and Multi-Linear Regression operations. Memory includes all necessary modules per each embodiment.

Memory may further include training set data 130 including, but not limited to, a set of product titles and a corresponding list of full 6-digits HS-Codes as will be later discussed. The ML general models may produce, based on the product title, a 6-digit HS Code.

Any suitable combination of hardware, software, or firmware may be used to implement memory and processor functions. For example, memory and processor functions may be implemented using a combination of computing devices in a distributed computing environment. In FIG. 1, HS-Code determination system 100 may assign a portion, or all, of memory and processing functions to any number of other computing devices 132. Other computing devices 132 may have equivalent hardware, software, or firmware to perform the functionality of the HS-Code determination system 100. Alternatively, other computing devices 132 may have the hardware, software, or firmware to solely perform certain functions, for example, memory for data storage.

FIG. 2 is a flowchart of the steps of a method 200 for training a machine learning model to predict HS-Codes, according to an embodiment. The method may consist of a first training phase 202, a second training phase 204, and a third training phase 206, as will be further described.

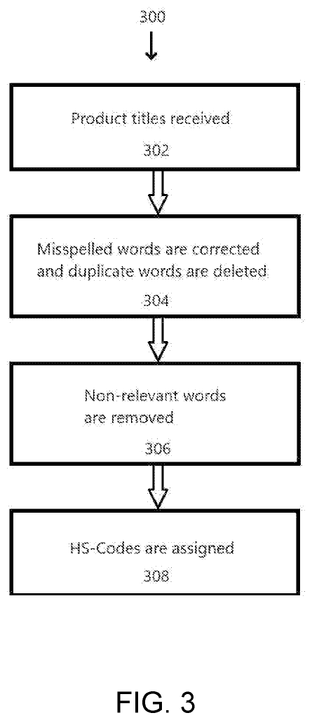

FIG. 3 is a flowchart of the steps of the first training phase 300. The first training phase 300 comprises data receival and preliminary data classification.

The first training phase 300 starts at block 302. A set of product titles is received. According to an embodiment, the set of product titles is inputted into the HS-Code determination system 100. For example, a user inputs a set of product titles such as

| | |
|---|---|
| Product_titles = | [flat screen television flat screen display |
| | nutritional cat food cat |
| | apple flavored all natural candies |
| | hamburger food] |

The first training phase 300 proceeds to block 304. For each product title, misspelled words are corrected and duplicate words are removed. For example, Product_titles becomes:

| | |
|---|---|
| Product_titles = | [flat screen television display |
| | nutritional cat food |
| | apple flavored all natural candies |
| | hamburger food] |

The first training phase 300 proceeds to block 306. For each product title, words that are deemed to be non-relevant or infrequently used for the product are removed. For example, an expert reviews the product titles and removes “display”, “nutritional”, “all natural”, and “food”.

| | |
|---|---|
| Product_titles = | [flat screen television |
| | cat food |
| | apple flavored candies |
| | hamburger] |

The first training phase 300 proceeds to block 308. An expert assigns an HS-Code to each product title. For example, an expert assigns HS-Codes of “111111”, “222222”, “333333”, and “444444” to the product titles.

| | | | |
|---|---|---|---|
| Product_titles = | [flat screen television | HS_Codes = | [111111 |
| | cat food | | 222222 |
| | apple flavored candies | | 333333 |
| | hamburger] | | 444444] |

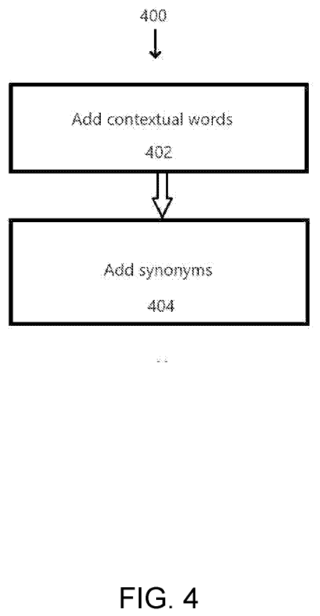

FIG. 4 is a flowchart of the steps of the second training phase 400. The second training phase 400 comprises data confirmation and data reclassification.

The second training phase 400 starts at block 402. Each of the product titles is examined, using natural language processing techniques (NLP), to produce additional contextual data. Examining the product titles as a sentence, rather than as a series of individual words, produces additional contextual data that can be used to differentiate HS_Codes for products having similar words in Product_titles. NLP processing techniques may include grammatical analysis, semantic analysis, and nearby word comparisons. For example, contextual data of “entertainment”, “non-human consumption”, “fruity”, and “beef”, is added to Product_titles.

| | | | |
|---|---|---|---|
| Product_titles = | [flat screen television entertainment | HS_Codes = | [111111 |
| | cat food non-human consumption | | 222222 |
| | apple flavored candies fruity | | 333333 |
| | hamburger beef] | | 444444] |

In alternative embodiments, the additional contextual data is generated based on the other product features. For example, if a sensor determines that a product has a mass of 20 kg, additional contextual data of “20 kg” is added to Product_titles. If a sensor determines that a product is from China, additional contextual data of “China” is added to Product_titles.

The second training phase 402 proceeds to block 404. The product titles are populated with relevant synonyms, the synonyms being related to the individual words. Populating the product titles with relevant synonyms improves the efficacy of the system 100 to relate certain words in a product title with its correct HS-Code. For example, synonyms of “TV”, “feline”, “candy”, and “steak”, is added to Product_titles.

| | | | |
|---|---|---|---|
| Product_titles = | [flat screen television TV entertainment | HS_Codes = | [111111 |
| | cat feline food non-human consumption | | 222222 |
| | apple flavored candies candy fruity | | 333333 |
| | hamburger beef steak] | | 444444] |

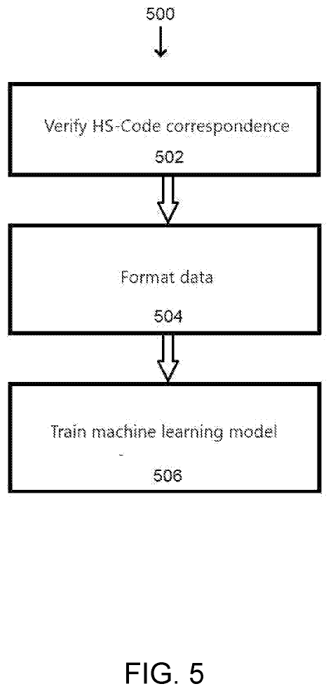

FIG. 5 is a flowchart of the steps of the third training phase 500. The third training phase 500 comprises data validation, data formatting, and training the machine learning model.

The third training phase 500 starts at block 502. Experts validate that the HS_Codes correspond to the products as described by their corresponding data in Product_titles. If an HS_Code does not correspond to a product as described by its corresponding data in Product_titles, the corresponding data in Product_titles can be modified. For example, an expert determines that the HS_Code of “444444” does not correspond to a ground beef product where the beef is a stake. As such, “steak” is removed from Product_titles.

| | | | |
|---|---|---|---|
| Product_titles = | [flat screen television TV entertainment | HS_Codes = | [111111 |
| | cat feline food non-human consumption | | 222222 |
| | apple flavored candies candy fruity | | 333333 |
| | hamburger beef] | | 444444] |

The third training phase 500 proceeds to block 504. The data is formatted when an inverse document frequency text processing operation is applied to the term frequency set of product titles, creating a term frequency-inverse document frequency set of product titles, that contain a measure of how much information a term has multiplied by the term frequency. For example, the system applies the inverse document frequency text preprocessing technique to Product_titles, creating the term frequency-inverse document frequency set of product titles such as:

| | | | |
|---|---|---|---|
| Product_titles = | [flat; 1, 0, 0 , 0 | HS_Codes = | [111111 |
| | screen; 1, 0, 0, 0 | | 111111 |
| | television; 1, 0, 0, 0 | | 111111 |
| | TV; 1, 0, 0, 0 | | 111111 |
| | entertainment; 1, 0, 0, 0 | | 111111 |
| | cat; 0, 1, 0, 0 | | 222222 |
| | feline; 0, 1, 0, 0 | | 222222 |
| | food; 0, 1, 0, 0 | | 222222 |
| | non-human consumption; 0, 1, 0, 0 | | 222222 |
| | apple; 0, 0, 1, 0 | | 333333 |
| | flavored; 0, 0, 1, 0 | | 333333 |
| | candies; 0, 0, 1, 0 | | 333333 |
| | candy; 0, 0, 1, 0 | | 333333 |
| | fruity; 0, 0, 1, 0 | | 333333 |
| | hamburger; 0, 0, 0, 1 | | 444444 |

The third training phase 500 proceeds to block 506. In a preferred embodiment, the machine learning model uses the Support Vector Machine algorithm to convert text data into mathematical matrices by increasing the number of dimensions to separate each word in each product title. The algorithm relies on temporarily creating dummy data in mathematical matrices for the purpose of create a gap between each HS-Code determination. In alternative embodiments, the machine learning model uses random forest, naïve bayes, or multi-linear regression algorithms. The machine learning model is trained using supervised learning where the Product_titles is the input and the HS_Codes is the output. This training process creates a machine learning model that outputs an HS-Code based on the terms in a product's title.

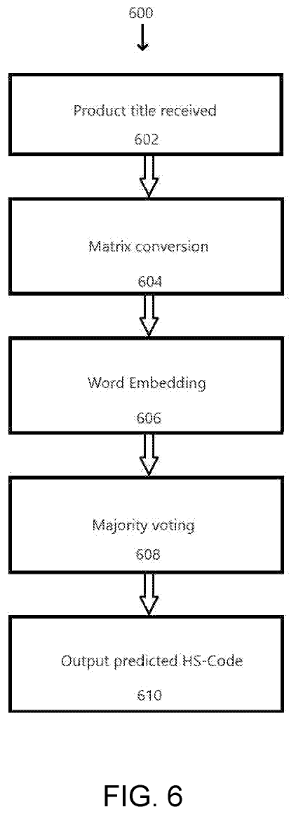

FIG. 6 is a flowchart of the steps of a first method 600 of determining the HS-Code of a product, according to one embodiment the present invention.

The method 600 starts at block 602. A user inputs a product title into the HS-code determination system 100 where the ML model of the system 100 has been trained according to the training method of FIG. 2.

The method 600 proceeds to block 604. The product title is converted to a complex mathematical matrices in advanced dimensions using the Global Vector Algorithm, where the product title is modeled to represent distributed words.

The method 600 proceeds to block 606. Similar words are assigned to spaces where they are related in terms of how different the similar words are from the words in the product title, and then the common link between the words is found and converted to blocks and numeric clusters that are used in the product titles of imported products. This is called word embedding 606.

The method 600 proceeds to block 608. The data, in matrix form, is then fed to the random forest algorithm of the trained ML model. The random forest algorithm works by taking the instance of data and then passing it by a plurality of decision trees. Each tree gives a prediction of an HS-Code based on the product title.

The method 600 proceeds to block 610. A majority voting step identifies the most probable prediction for the HS-Code. This predicted HS-Code is output to the user.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology. Although the present disclosure has been explained in relation to its preferred embodiment(s) as mentioned above, it is to be understood that many other possible modifications and variations can be made without departing from the spirit and scope of the inventive aspects of the present invention. It is, therefore, contemplated that the appended claim or claims will cover such modifications and variations that fall within the true scope of the invention.

I claim:

1. A computer-implemented method of training a machine learning general model to determine an HS-Code based on a product title, the method comprising:
receiving, by a computing device, a set of product titles;
removing, by the computing device, duplicate words from the set of product titles;
removing, by an expert, non-relevant words from the set of product titles;
adding, by the computing device, contextual words to the set of product titles;
adding, by the computing device, synonym words to the set of product titles;
assigning, by the expert, an HS-Code to each of the product titles;
verifying, by the expert, that a given HS-Code corresponds, based on the words in its product title, to a product, wherein
when the given HS-Code does not correspond, based on the words in its product title, to the product, non-corresponding content is removed;
applying, by the computing device, a term frequency operation and an inverse document frequency operation to each of the product titles to create a set of product terms;
creating a training set comprising the set of product terms and the set of HS-Codes; and
training the machine learning model with the training set using supervised learning,
wherein the set of product terms is an input and the set of HS-Codes is a desired output.

2. The method of claim 1, wherein the machine learning general model is trained using a random forest algorithm.

3. A computer-implemented method of training a machine learning general model to determine an HS-Code based on a product title, the method comprising:
receiving, by a computing device, a set of product titles;
removing, by the computing device, duplicate words from the set of product titles;
adding, by the computing device, contextual words to the set of product titles;
assigning, by the expert, an HS-Code to each of the product titles;
applying, by the computing device, a term frequency operation and an inverse document frequency operation to each of the product titles to create a set of product terms;
creating a training set comprising the set of product terms and the set of HS-Codes; and
training the machine learning model with the training set using supervised learning,
wherein the set of product terms is an input and the set of HS-Codes is a desired output.

4. The method of claim 3, further comprising steps of:
removing, by an expert, non-relevant words from the set of product titles.

5. The method of claim 3, further comprising steps of:
adding, by the computing device, synonym words to the set of product titles.

6. The method of claim 3, further comprising steps of:
verifying, by the expert, that a given HS-Code corresponds, based on the words in its product title, to a product, wherein
when the given HS-Code does not correspond, based on the words in its product title, to the product, non-corresponding content is removed.

7. The method of claim 3, further comprising steps of:
removing, by an expert, non-relevant words from the set of product titles;
adding, by the computing device, synonym words to the set of product titles; and
verifying, by the expert, that a given HS-Code corresponds, based on the words in its product title, to a product, wherein
when the given HS-Code does not correspond, based on the words in its product title, to the product, non-corresponding content is removed.

8. The method of claim 3, wherein the machine learning general model is trained using a random forest algorithm.

9. A system for identifying an HS-Code based on a product title, the system comprising:
an input device configured to receive the product title;
a processor;
memory;
a machine learning model stored in the memory and executed in the processor, the model trained by:
receiving, by a computing device, a set of product titles;
removing, by the computing device, duplicate words from the set of product titles;
removing, by an expert, non-relevant words from the set of product titles;
adding, by the computing device, contextual words to the set of product titles;
adding, by the computing device, synonym words to the set of product titles;
assigning, by the expert, an HS-Code to each of the product titles;
verifying, by the expert, that a given HS-Code corresponds, based on the words in its product title, to a product, wherein
when the given HS-Code does not correspond, based on the words in its product title, to the product, non-corresponding content is removed;
applying, by the computing device, a term frequency operation and an inverse document frequency operation to each of the product titles to create a set of product terms;
creating a training set comprising the set of product terms and the set of HS-Codes; and
training the machine learning model with the training set using supervised learning, wherein the set of product terms is an input and the set of HS-Codes is a desired output.
an output device configured to display the HS-Code, wherein the HS-Code corresponds to the product title.

10. The method of claim 9, wherein the machine learning model is further trained by:
removing, by an expert, non-relevant words from the set of product titles.

11. The method of claim 9, wherein the machine learning model is further trained by:
adding, by the computing device, synonym words to the set of product titles.

12. The method of claim 9, wherein the machine learning model is further trained by:
verifying, by the expert, that a given HS-Code corresponds, based on the words in its product title, to a product, wherein
when the given HS-Code does not correspond, based on the words in its product title, to the product, non-corresponding content is removed.

13. The method of claim 9, wherein the machine learning model is further trained by:
removing, by an expert, non-relevant words from the set of product titles;
adding, by the computing device, synonym words to the set of product titles; and
verifying, by the expert, that a given HS-Code corresponds, based on the words in its product title, to a product, wherein
when the given HS-Code does not correspond, based on the words in its product title, to the product, non-corresponding content is removed.

14. The system of claim 9, wherein the machine learning general model is trained using a random forest algorithm.
